(19) United States
(12) Patent Application Publication
(10) Pub. No.: US 2023/0106889 A1
(43) Pub. Date: Apr. 6, 2023

(54) RECIPROCATING SAW

(71) Applicant: MILWAUKEE ELECTRIC TOOL CORPORATION, Brookfield, WI (US)

(72) Inventor: Carmen J. CASTANOS, Milwaukee, WI (US)

(21) Appl. No.: 17/045,662

(22) PCT Filed: Aug. 28, 2020
(86) PCT No.: PCT/US2020/048400

§ 371 Date: Oct. 6, 2020

Related U.S. Application Data
(60) Provisional application No. 62/893,542, filed on Aug. 29, 2019.

(51) Int. Cl. B23D 51/16; B23D 49/16

(52) U.S. Cl. CPC B23D 51/16; B23D 49/162

(57) ABSTRACT

A reciprocating saw includes a housing, a motor positioned within the housing, the motor including a pinion rotatable about a motor axis, and a drive mechanism positioned within the housing and coupled to the motor. The drive mechanism includes a driven gear that engages the pinion and is rotated by the motor, and an output shaft driven by the motor to reciprocate relative to the housing. The output shaft is configured to support a tool element adjacent a forward portion of the housing. The drive mechanism includes a first counterweight coupled to the driven gear for rotation with the driven gear about a rotational axis, and a second counterweight spaced apart from the first counterweight and integrally formed with the driven gear. The first counterweight and the second counterweight are driven by the motor to rotate relative to the housing along a path.

### CROSS-REFERENCE TO RELATED APPLICATIONS

This application claims priority to U.S. Provisional Patent Application No. 62/893,542 filed on Aug. 29, 2019, the entire content of which is incorporated herein by reference.

### FIELD OF THE INVENTION

The present invention relates to power tools, and more particularly to reciprocating saws.

### BACKGROUND OF THE INVENTION

Power tools include different types of drive mechanisms to perform work. Power tools with reciprocating-type drive mechanisms commonly include counterweights to counterbalance forces generated by output elements (e.g., saw blades) during reciprocating movement.

### SUMMARY OF THE INVENTION

The invention provides, in one aspect, a reciprocating saw including a housing, a motor positioned within the housing, the motor including a pinion rotatable about a motor axis, and a drive mechanism positioned within the housing and coupled to the motor, the drive mechanism including a driven gear that engages the pinion and is rotated by the motor, an output shaft driven by the motor to reciprocate relative to the housing, the output shaft configured to support a tool element adjacent a forward portion of the housing, a first counterweight coupled to the driven gear for rotation with the driven gear about a rotational axis, and a second counterweight spaced apart from the first counterweight and integrally formed with the driven gear, wherein the first counterweight and the second counterweight are driven by the motor to rotate relative to the housing along a path.

The invention provides, in another aspect, a reciprocating saw including a housing, a motor positioned within the housing, the motor including a pinion rotatable about a motor axis, and a drive mechanism positioned within the housing and coupled to the motor, the drive mechanism including a driven gear that engages the pinion and is rotated by the motor, an output shaft driven by the motor to reciprocate relative to the housing, the output shaft configured to support a tool element adjacent a forward portion of the housing, a first counterweight coupled to the driven gear for rotation with the driven gear about a rotational axis, a connecting rod pivotably coupled to the first counterweight at a first end thereof about a pivot axis, and a second counterweight spaced apart from the first counterweight and integrally formed with the driven gear, wherein the first counterweight and the second counterweight are driven by the motor to rotate relative to the housing along a path, wherein a center of mass of the first counterweight is offset from a reference plane intersecting and containing therein the rotational axis and the pivot axis.

The invention provides, in another aspect, a reciprocating saw including a housing, a motor positioned within the housing, the motor including a pinion rotatable about a motor axis, and a drive mechanism positioned within the housing and coupled to the motor, the drive mechanism including a driven gear that engages the pinion and is rotated by the motor, an output shaft driven by the motor to reciprocate relative to the housing along a spindle axis that is coaxial with the motor axis, the output shaft configured to support a tool element adjacent a forward portion of the housing, a first counterweight extending along a main axis and coupled to the driven gear for rotation with the driven gear about a rotational axis, a connecting rod pivotably coupled to the first counterweight at a first end thereof about a pivot axis, and a second counterweight spaced apart from the first counterweight and integrally formed with the driven gear, wherein the first counterweight and the second counterweight are driven by the motor to rotate relative to the housing along a path, wherein a center of mass of the first counterweight is offset from a reference plane intersecting and containing therein the rotational axis and the pivot axis, wherein operation of the reciprocating saw generates vibration in a first direction extending along an X-axis that is collinear with the spindle axis, and in a second direction extending along a Y-axis that is orthogonal to the spindle axis, and wherein the drive mechanism is configured to cut through a two-inch schedule 40 pipe with an X-axis vibration of 9 m/s² or less, while maintaining a Y-axis vibration of at least 5 m/s², within a time period of less than 23 seconds.

Other features and aspects of the invention will become apparent by consideration of the following detailed description and accompanying drawings.

### BRIEF DESCRIPTION OF THE DRAWINGS

FIG. 1 is a perspective view of a reciprocating saw embodying the invention.

FIG. 2 is a side view of the reciprocating saw of FIG. 1 with a portion of the housing removed.

FIG. 3 is a top view of the reciprocating saw of FIG. 1 with a portion of the housing removed.

FIG. 4 is a perspective view of a portion of a drive mechanism of the reciprocating saw of FIG. 1.

FIG. 5 is a front perspective view of a first counterweight of the reciprocating saw of FIG. 1.

FIG. 6 is an enlarged, cross-sectional view of a portion of the reciprocating saw of FIG. 2.

FIG. 7 is a graph illustrating vibration of the drive mechanism along X, Y, and Z axes as shown in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

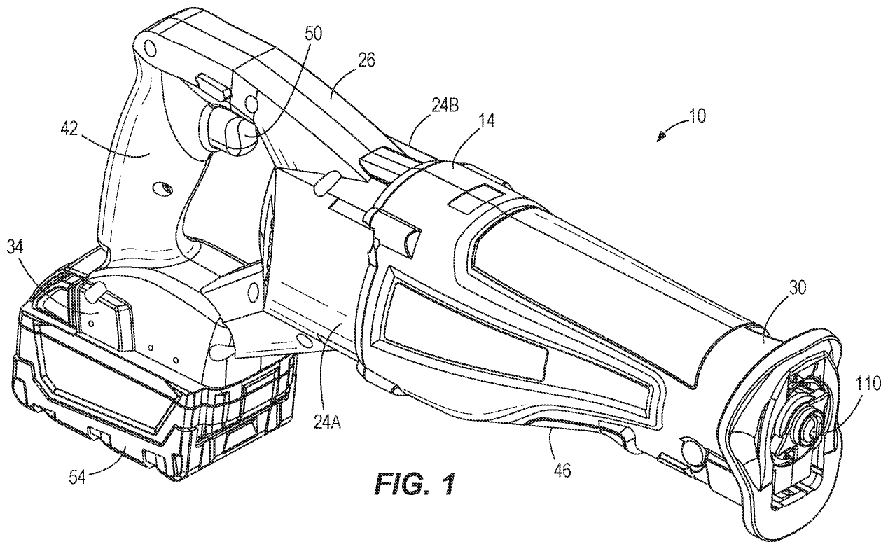

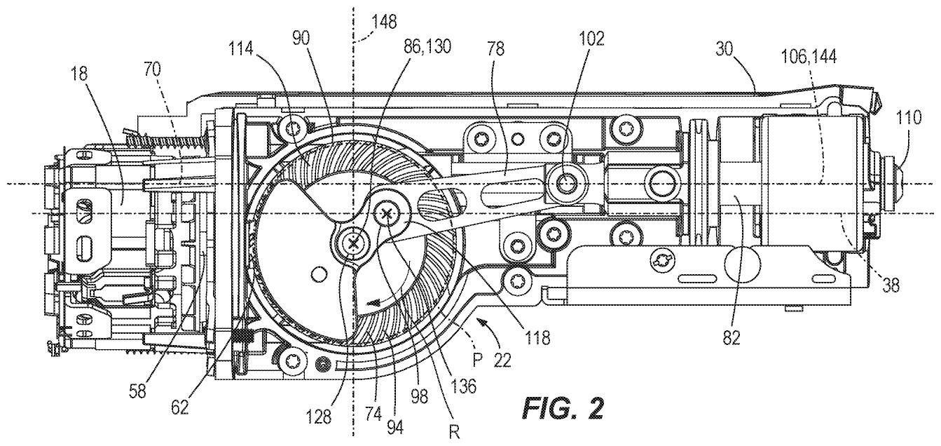

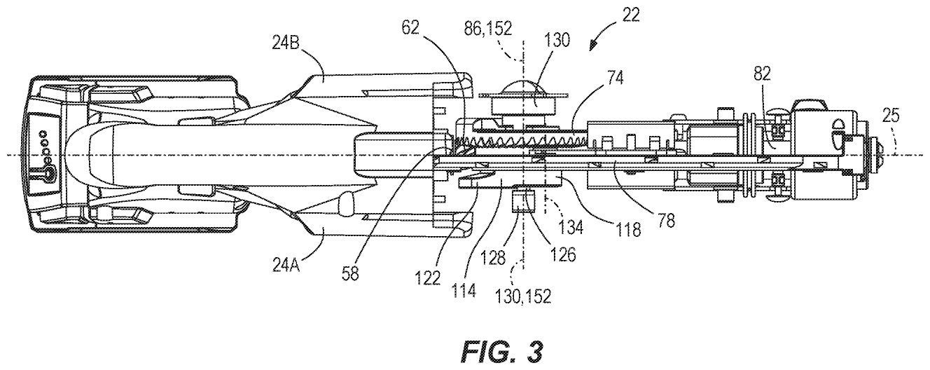

FIGS. 1-3 illustrate a reciprocating saw 10 including a housing 14, a motor 18 positioned within the housing 14, and a drive mechanism 22 coupled to the motor 18 and positioned within the housing 14. As shown in FIG. 1, the housing 14 is comprised of two clamshell halves 24A, 24B that are connected along a plane 25 (FIG. 3). In the illustrated embodiment, the clamshell halves 24A, 24B are secured together with threaded fasteners (e.g., screws), but may alternatively be secured together using other suitable coupling means. FIG. 2 illustrates the reciprocating saw 10 with one of the clamshell halves 24A removed to illustrate the internal components (e.g., the motor 18, the drive mechanism 22, etc.) of the saw 10.

Referring to FIG. 1, the housing 14 includes a rearward portion 26, a forward portion 30, and a battery support portion 34. The housing 14 also defines a longitudinal axis 38 (FIG. 2) that extends through the rearward and forward portions 26, 30. The rearward portion 26 includes a D-shaped handle 42, and the forward portion 30 includes a grip 46. The D-shaped handle 42 and the grip 46 are configured to be grasped by a user during operation of the reciprocating saw 10. An actuator or trigger 50 is supported by the rearward portion 26 adjacent the D-shaped handle 42. The trigger 50 is actuatable by a user to selectively power the motor 18. In the illustrated embodiment, the trigger 50 is positioned above the longitudinal axis 38, and the longitudinal axis 14 generally divides the housing 14 into an upper section and a lower section. A shoe extends from and is pivotally coupled the forward portion 30 of the housing 14. The shoe (not shown) pivots about a pivot axis and facilitates aligning the reciprocating saw 10 on a work piece to be cut.

The battery support portion 34 is formed on the rearward portion 26 of the housing 14 below the D-shaped handle 42. In the illustrated embodiment, the battery support portion 34 is located beneath the longitudinal axis 38 of the housing 14 when the reciprocating saw 10 is viewed as shown in FIG. 2. In other embodiments, the battery support portion 34 may be located elsewhere on the housing 14. The battery support portion 34 is configured to receive a battery pack 54 (e.g., an 18-Volt Li-ion power tool battery pack) (FIG. 1) and electrically connect the battery pack 54 to the motor 18. In other embodiments, the battery pack 54 may have different voltages and/or chemistries. In still other embodiments, the reciprocating saw 10 may include a power cord such that the motor 18 is powered by an AC power source (e.g., a wall outlet, a portable generator, etc.).

As shown in FIG. 2, the motor 18 is positioned within the housing 14 between the rearward portion 26 and the forward portion 30. The motor 18 is also electrically connected to the battery pack 54 (or other suitable power source) through the trigger 50 and includes a motor shaft 58 and an output gear or pinion 62. The motor shaft 58 defines a central axis, or motor axis 70, of the motor 18. In the illustrated embodiment, the motor axis 70 of the motor 18 is generally aligned or coaxial with the longitudinal axis 38 of the housing 14. When powered, the motor 18 rotates the motor shaft 58 and the pinion 62 about the axis 70 to drive the drive mechanism 22.

As shown in FIGS. 2 and 3, the drive mechanism 22 is positioned at least partially within the forward portion 30 of the housing 14 between the motor 18 and the shoe. The illustrated drive mechanism 22 is a slider-crank mechanism that includes a driven gear 74, a connecting rod 78, and an output shaft 82. The driven gear 74 engages the pinion 62 of the motor 18 and defines a central axis 86 about which the gear 74 rotates. In the illustrated embodiment, the central axis 86 is perpendicular to the longitudinal axis 38 of the housing 14 and extends between opposing sides of the housing 14. More particularly, the central axis 86 is perpendicular to the plane 25 (FIG. 3) along which the clamshell halves 24A, 24B of the housing 14 are connected. The driven gear 74 is thereby vertically oriented within the housing 14. With reference to FIG. 6, the saw 10 additionally includes one or more cylindrical sleeves 88 surrounding the shaft 82. Specifically, sleeves 88 are positioned within a bushing assembly 92 which, in turn, is supported within the housing 14.

The longitudinal axis 38 of the housing 14 and the motor axis 70 of the motor 18 extend through a center of the gear 74 (i.e., through the central axis 86) to divide the gear 74 into a first, or upper, portion 90 and a second, or lower, portion 94. In the illustrated embodiment, the upper portion 90 of the driven gear 74 is located on the same side of the longitudinal axis 38 as the output shaft 82 and the trigger 50, while the lower portion 94 of the driven gear 74 is located on the same side of the longitudinal axis 38 as the battery support portion 34. In other embodiments, the output shaft 82 may be located on the opposite side of the longitudinal axis 38 such that the lower portion 94 of the driven gear 74 is located on the same side of the longitudinal axis 38 as the output shaft 38. It should be understood what constitutes the upper and lower portions 90, 94 of the driven gear 74 changes during operation of the drive mechanism 22 because the gear 74 rotates. The terms “upper” and “lower” are simply illustrative terms used to help describe volumes of spaces above and below the axes 38, 70 that are occupied by sections of the gear 74 at any given time. At any particular instance in time, the actual section of the gear 74 that qualifies as the “upper portion” or the “lower portion” is different than at another instance in time.

The connecting rod 78, or drive arm, includes a first end that is coupled to the driven gear 74 by a crank pin 98 and a second end that is coupled to the output shaft 82 by a pivot pin 102. The crank pin 98 is offset from the central axis 86 of the driven gear 74 such that, as the gear 74 is rotated, the crank pin 98 moves about the central axis 86. As the first end of the connecting rod 78 moves with the driven gear 74, the second end of the connecting rod 78 pushes and pulls the output shaft 82 in a reciprocating motion. The crank pin 98 allows the connecting rod 78 to pivot vertically relative to the driven gear 74, while the pivot pin 102 allows the connecting rod 78 to pivot vertically relative to the output shaft 82.

The output shaft 82, or spindle, reciprocates within the forward portion 30 of the housing 14 generally along a spindle axis 106. In the illustrated embodiment, the spindle axis 106 is generally parallel to and positioned above the longitudinal axis 38 of the housing 14. Rotary motion of the motor 18 is thereby translated into linear reciprocating motion of the output shaft 82 by the driven gear 74 and the connecting rod 78.

The motor axis 70 and the spindle axis 106 together define a plane. The driven gear 74 is vertically oriented within the housing 14 in that the gear 74 rotates about an axis (i.e., the central axis 86) that is perpendicular to the plane defined by the motor and spindle axes 70, 106. In the illustrated embodiment, the plane defined by the motor and spindle axis 70, 106 is the same as the plane 25 (FIG. 3) along which the clamshell halves 24A, 24B are coupled together. In other embodiments, one or both of the motor and spindle axes 70, 106 may be offset from, yet still parallel to the plane 25.

With continued reference to FIG. 2, a blade clamp 110 is coupled to an end of the output shaft 82 opposite from the connecting rod 78. The blade clamp 110 receives and secures a saw blade, or other tool element, to the output shaft 82 for reciprocating movement with the output shaft 82. The output shaft 82 supports the saw blade such that, during operation of the reciprocating saw 10, the drive mechanism 22 moves the saw blade through a cutting stroke when the output shaft 82 is pulled by the connecting rod 78 from an extended position to a retracted position, and through a return stoke when the output shaft 82 is pushed by the connecting rod 78 from the retracted position to the extended position.

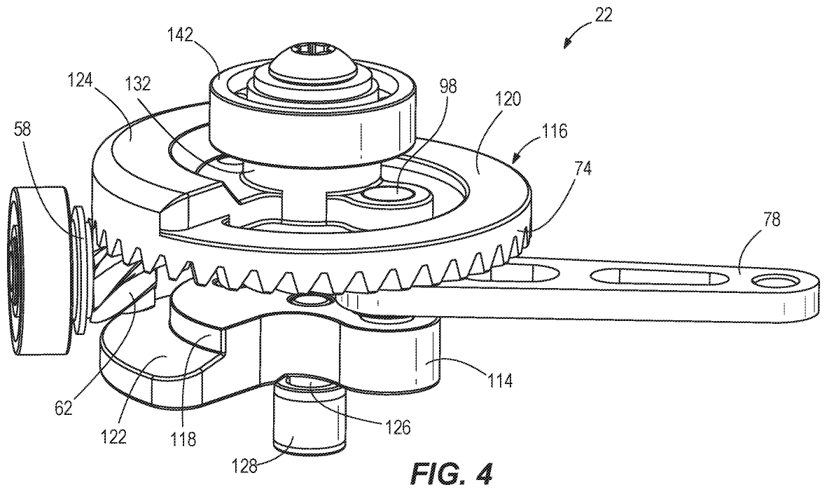

With reference to FIG. 4, the illustrated drive mechanism 22 also includes a first counterweight 114 and a second counterweight 116. The first and second counterweights 114, 116 help balance forces generated by the output shaft 82 and pin 102 during reciprocating movement. In the illustrated embodiment, the first counterweight 114 and the second counterweight 116 are separate elements but may alternatively be integrally formed as a single piece. More specifically, the second counterweight 116 and the driven gear 74 are integrally formed as a single piece, and the first and second counterweights 114, 116 are spaced apart from each other along the axis 86. In alternative embodiments, the second counterweight 116 and the driven gear 74 may be separate components.

The illustrated first counterweight 114 includes a hub or connection portion 118 and a mass portion 122. The connection portion 118 is pivotably coupled to the connecting rod 78 via the crank pin 98. A first guide pin 126 also extends from the connection portion 118 and is rotatably supported within the housing 14 by a bushing 128. The first guide pin 126 (FIGS. 3-4) supports the first counterweight 114 within the housing 14 and defines an axis of rotation 130 of the first counterweight 114. In the illustrated embodiment, the axis of rotation 130 of the first counterweight 114 and the central axis 86 of the driven gear 74 (i.e., the second counterweight 116) are coaxial so that the first counterweight 114 and the driven gear 74 (and the second counterweight 116) rotate about the same axis. Similar to the driven gear 74, the first counterweight 114 is, therefore, also vertically oriented within the housing 14. In the illustrated embodiment, the axis of rotation 130 intersects and is perpendicular to the motor axis 70.

The mass portion 122 of the first counterweight 114 extends from the connection portion 118 and includes a majority of the mass of the first counterweight 114. More specifically, the mass portion 122 of the first counterweight 114 extends in a radially outward direction from the connection portion 118. In the illustrated embodiment, the mass portion 122 has a generally semi-circular shape to match the circular shape and contour of the driven gear 74. That is, the first counterweight 114 is shaped and sized so it lies within a vertical footprint area defined by the driven gear 74. Such an arrangement reduces the amount of space required within the housing 14 to accommodate the counterweight 114. In other embodiments, the mass portion 122 may have other suitable shaped or configurations.

The second counterweight 116 additionally includes a connection portion 120 and a mass portion 124. As shown in FIGS. 3-4, the hub or connection portion 120 of the second counterweight 116 is integral with the driven gear 74. The connection portion 120 is pivotably coupled to the connecting rod 78 via the crank pin 98. A second guide pin 132 also extends from the connection portion 120 and is rotatably supported within the housing 14 by a bearing 142. The second guide pin 132 supports the second counterweight 116 and the driven gear 74 within the housing 14 along the axis of rotation 130 of the first counterweight 114 and the central axis 86 of the driven gear 74.

The mass portion 124 of the second counterweight 116 extends from the connection portion 120 in a radially outward direction. The mass portion 124 of the second counterweight 116 is offset from the mass portion 122 of the first counterweight 114 in a direction parallel with the rotational axis 130 of the first counterweight 114. The mass portion 124 of the second counterweight 116 has a generally semi-circular shape and matches the circular shape and contour of the driven gear 74. Specifically, the mass portion 124 of the second counterweight 116 lies within the vertical footprint area defined by the driven gear 74, and aligns the first and second counterweights 114, 116. This arrangement reduces the amount of space required within the housing 14 to accommodate the second counterweight 116. In other embodiments, the mass portion 124 of the second counterweight 116 may have other suitable shaped or configurations.

With continued reference to FIGS. 2 and 4, the crank pin 98 aligns the first counterweight 114 and the driven gear 74 such that the first and second mass portions 122, 124 are substantially aligned. Therefore, movement of the mass portions 122, 124 in a direction opposite the movement of the output shaft 82 tends to balance the forces generated during reciprocation of the saw blade in a front-to-back direction.

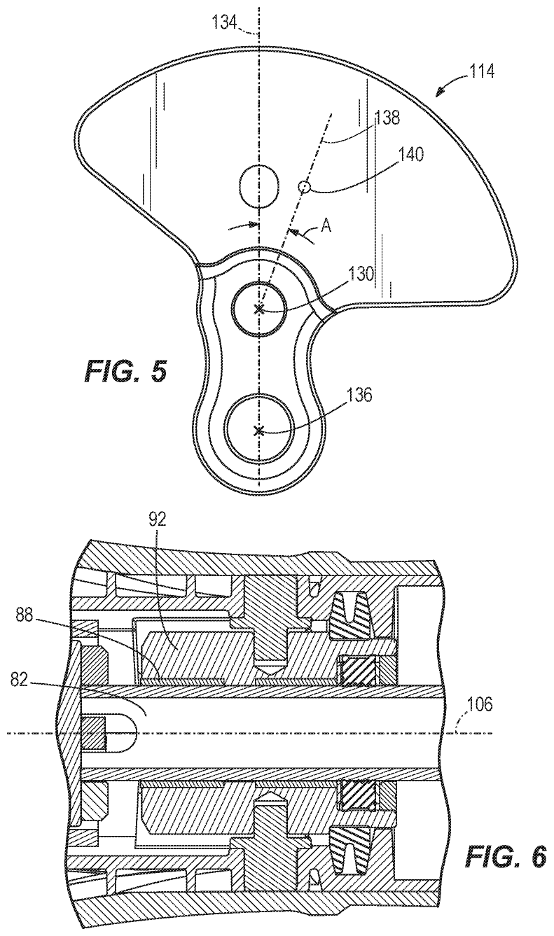

As the driven gear 74 rotates and drives the crank pin 98, the mass portions 122, 124 are moved in a substantially opposite direction than the output shaft 82 to counterbalance the inertial forces of the output shaft 82 and attached saw blade. In particular, the mass portions 122, 124 are in a first position (e.g., relatively close to the motor 18 and relatively far from the output shaft 82), as shown in FIG. 2, when the output shaft 82 is in the extended position. The mass portions 122, 124 rotate to a second position (e.g., relatively close to the output shaft 82 and relatively far from the motor 18) when the output shaft 82 is in the retracted position. Furthermore, as shown in FIG. 5, the first counterweight 114 defines a reference plane 134 that intersects and contains therein the rotational axis 130 of the counterweight 114 and a pivot axis 136 (FIGS. 2-3) of the crank pin 98. The first counterweight 114 includes a phase angle A (FIG. 5) extending between the reference plane 134 and a line of action 138 intersecting a center of mass 140 of the counterweight 114 and the rotational axis 130 of the first counterweight 114. In the illustrated embodiment, the phase angle A is 21 degrees. The phase angle A is sized such that the center of mass 140 of the first counterweight 114 is very near its rearmost position along a circular path P (FIG. 2) when the output shaft 82 is at its forwardmost (i.e., extended) position. Also, when the output shaft 82 is at its forwardmost position, the center of mass 140 of the first counterweight 114 is intersected by the longitudinal axis 38.

In the illustrated embodiment, the counterweights 114, 116 rotate along a path P in a clockwise direction (when viewing the reciprocating saw 10 as shown in FIG. 2) about the axis of rotation 130 between the first and second positions. That is, the mass portions 122, 124 of the counterweights 114, 116 travel generally above the longitudinal axis 38 of the housing 14 during the cutting stroke of the output shaft 82 to move from the first position to the second position. The mass portion 124 of the second counterweight 116 is rotationally aligned and in phase with the mass portion 122 of the first counterweight 114 along the path P. Conversely, the mass portions 122, 124 of the counterweights 114, 116 travel generally below the longitudinal axis 38 of the housing 14 during the return stroke of the output shaft 82 to move from the second position to the first position. Stated another way, as the mass portions 122, 124 of the counterweights 114, 116 move through a rearward half of the path P (i.e., the half of the path P that is closer to the rearward portion 26 of the housing 14) at the end of the return stroke and start of the cutting stroke, the mass portions 122, 124 generally move in an upward direction (as viewed in FIG. 2) and toward the spindle axis 106. As the mass portions 122, 124 of the counterweights 114, 116 move through a forward half of the path P (i.e., the half of the path P that is closer to the forward portion 30 of the housing 14) at the end of the cutting stroke and start of the return stroke, the mass portions 122, 124 generally move in a downward direction (as viewed in FIG. 2) and away from the spindle axis 106. This movement of the first and second counterweights 114, 116 causes the front of the saw 10 to tend to move into a work piece (downward in FIG. 2) as the cutting stroke begins.

In the illustrated embodiment, the mass of various components of the drive mechanism (e.g., the output shaft 82, the crank pin 98, etc.) is reduced. As a result, the mass of the first counterweight 114 may be reduced and distributed into the second counterweight 116, as discussed above, while also allowing for an increase in stroke length of the output shaft 82. In the illustrated embodiment, the stroke of the output shaft 82 is 1.25 inches, an increase of 10% over prior art reciprocating saws of a similar size but with a single counterweight integrally formed with the drive gear.

Because the first counterweight 114 is coupled to the driven gear 74 by the crank pin 98, the first counterweight 114 and the second counterweight 116 rotate together through the path P. As discussed above, the terms “upper portion” and “lower portion” of the driven gear 74 refer to volumes of space occupied by sections of the gear 74 during operation of the drive mechanism 22.

The arrangement of the first counterweight 114 and the driven gear 74 increases cutting performance of the reciprocating saw 10 compared with rotation of the first and second counterweights 114, 116 in the opposite direction (e.g., counterclockwise when viewing the reciprocating saw 10 as shown in FIG. 2). In particular, the mass portions 122, 124 of the counterweights 114, 116 tend to move the saw 10 in the cutting direction during the non-cutting stroke, which helps drive the reciprocating saw 10 and the saw blade into the work piece at the start of the next cutting stroke. In contrast, if the counterweights 114, 116 are rotated in the opposite direction, the reciprocating saw 10 and the saw blade may tend to move away from the work piece during the start of the next cutting stroke. By rotating the counterweights 114, 116 in the clockwise direction R, a user can more easily initiate cuts into a work piece and significantly reduce the amount of time required to cut through the work piece. In the illustrated embodiment, the saw 10 is capable of cutting through a two-inch schedule 40 pipe in less than 23 seconds. In some embodiments, the saw 10 is capable of cutting through a two-inch schedule 40 pipe in 21.9 seconds. Additionally, by rotating the counterweights 114, 116 in the clockwise direction R, the time for cutting through a piece of 2″×12″ wood or other lumber is reduced compared to rotating the counterweights 114, 116 in an opposite (i.e., counter-clockwise) direction.

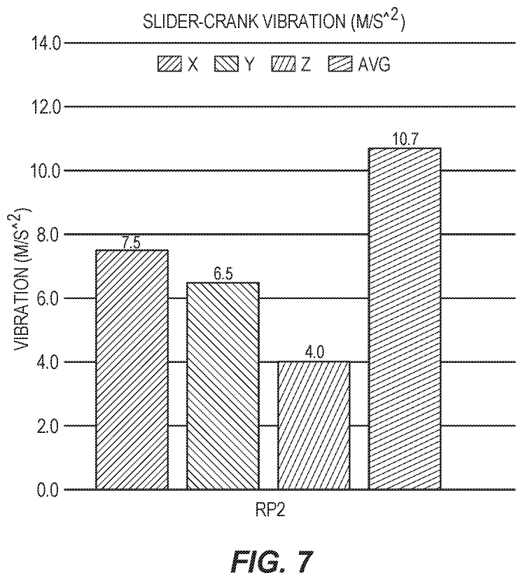

During operation of the saw 10, vibration generated by the reciprocating saw 10 may fluctuate in a horizontal direction and a vertical direction. With reference to FIG. 2, the horizontal direction is the direction extending along an X-axis 144. The X-axis 144 extends along and is collinear with the spindle axis 106. The vertical direction is the direction extending along a Y-axis 148. The Y-axis 148 is substantially orthogonal to the spindle axis 106 of the rotational axes 86, 130 of the driven gear 74 and the counterweights 114, 116. Furthermore, vibration may fluctuate in a direction extending along a Z-axis 152 (FIG. 3). The Z-axis 152 is positioned substantially orthogonal to both the X-axis 144 and the Y-axis 148 and extends along and is collinear with the rotational axes 86, 130 of the driven gear 74 and counterweights 114, 116. The velocity of the saw 10 lags its acceleration. Thus, the velocity of the counterweights 114, 116 in the clockwise-rotating saw 10 is downward at the end of the return stroke and at the beginning of the cutting stroke. This downward velocity results in a force that drives the saw 10, and more particularly the saw blade, into a work piece to start cutting the work piece. Due to the reduced mass of the drive mechanism 22 and the increased stroke length, the vibration generated in the vertical direction may be maximized, and the vibration in the horizontal direction, which is that most readily perceived by an operator of the saw 10, may be minimized. During no-load testing (i.e., without an attached saw blade), in one embodiment as shown in FIG. 7, it was determined that the magnitude of vibration of the saw 10 is approximately 6.5 m/s² in the vertical direction (i.e., along the Y-axis), whereas the magnitude of vibration of the saw 10 is less than 8 m/s² in the horizontal direction (i.e., along the X-axis), and in some embodiments approximately 7.5 m/s² or less. In other embodiments, the magnitude of vibration of the saw 10 is approximately 5.75 m/s² in the vertical direction (i.e., along the Y-axis), whereas the magnitude of vibration of the saw 10 is less than 9 m/s² in the horizontal direction (i.e., along the X-axis). As mentioned above, X-axis vibration is more readily perceived by an operator of the saw 10, and Y-axis vibration has some attendant benefits (e.g., plunging the saw blade into the workpiece during a cutting stroke). Therefore, it is desirable to minimize X-axis vibration while not attenuating, or in some embodiments increasing, Y-axis vibration, both of which are accomplished with the saw 10.

Although the invention has been described in detail with reference to certain preferred embodiments, variations and modifications exist within the scope and spirit of one or more independent aspects of the invention as described.

Various features of the invention are set forth in the following claims.

What is claimed is:

1. A reciprocating saw comprising:
a housing;
a motor positioned within the housing, the motor including a pinion rotatable about a motor axis; and
a drive mechanism positioned within the housing and coupled to the motor, the drive mechanism including
a driven gear that engages the pinion and is rotated by the motor,
an output shaft driven by the motor to reciprocate relative to the housing, the output shaft configured to support a tool element adjacent a forward portion of the housing,
a first counterweight coupled to the driven gear for rotation with the driven gear about a rotational axis, and
a second counterweight spaced apart from the first counterweight and integrally formed with the driven gear, wherein the first counterweight and the second counterweight are driven by the motor to rotate relative to the housing along a path.

2. The reciprocating saw of claim 1, wherein as the first counterweight and the second counterweight move through a rearward half of the path, the first counterweight and the second counterweight generally move in an upward direction, and as the first counterweight and the second counterweight move through a forward half of the path, the first counterweight and the second counterweight generally move in a downward direction.

3. The reciprocating saw of claim 1, wherein the drive mechanism further comprises a connecting rod pivotably coupled to the first counterweight at a first end thereof about a pivot axis, and wherein a center of mass of the first counterweight is offset from a reference plane intersecting and containing therein the rotational axis and the pivot axis.

4. The reciprocating saw of claim 3, wherein the first counterweight includes a phase angle extending between the reference plane and a line of action intersecting the center of mass of the first counterweight and the rotational axis of the first counterweight.

5. The reciprocating saw of claim 4, wherein the phase angle is 21 degrees.

6. The reciprocating saw of claim 1, wherein the drive mechanism is configured to cut through a two-inch schedule 40 pipe within a time period of less than 23 seconds.

7. The reciprocating axis of claim 1, wherein the output shaft reciprocates along a spindle axis, and wherein the spindle axis is coaxial with the motor axis.

8. The reciprocating saw of claim 7, wherein operation of the reciprocating saw generates vibration in a first direction extending along an X-axis that is collinear with the spindle axis, and in a second direction extending along a Y-axis that is orthogonal to the spindle axis.

9. The reciprocating saw of claim 8, wherein the drive mechanism is configured to cut through a two-inch schedule 40 pipe with an X-axis vibration of 9 m/s² or less while maintaining a Y-axis vibration of at least 5 m/s².

10. The reciprocating saw of claim 9, wherein the X-axis vibration is 7.5 m/s² or less.

11. The reciprocating saw of claim 1, wherein the first counterweight includes a first mass portion, wherein the second counterweight includes a second mass portion offset from the first mass portion in a direction parallel with the rotational axis of the first counterweight, and wherein the second mass portion is rotationally aligned and in phase with the first mass portion along the path.

12. A reciprocating saw comprising:
a housing;
a motor positioned within the housing, the motor including a pinion rotatable about a motor axis; and
a drive mechanism positioned within the housing and coupled to the motor, the drive mechanism including
a driven gear that engages the pinion and is rotated by the motor,
an output shaft driven by the motor to reciprocate relative to the housing, the output shaft configured to support a tool element adjacent a forward portion of the housing,
a first counterweight coupled to the driven gear for rotation with the driven gear about a rotational axis,
a connecting rod pivotably coupled to the first counterweight at a first end thereof about a pivot axis, and
a second counterweight spaced apart from the first counterweight and integrally formed with the driven gear, wherein the first counterweight and the second counterweight are driven by the motor to rotate relative to the housing along a path,
wherein a center of mass of the first counterweight is offset from a reference plane intersecting and containing therein the rotational axis and the pivot axis.

13. The reciprocating saw of claim 12, wherein the first counterweight includes a phase angle extending between the reference plane and a line of action intersecting the center of mass of the first counterweight and the rotational axis of the first counterweight.

14. The reciprocating saw of claim 13, wherein the phase angle is 21 degrees.

15. The reciprocating saw of claim 13, wherein when the output shaft is at an extended position, the center of mass of the first counterweight is positioned proximate a rearwardmost position along the path.

16. The reciprocating saw of claim 12, wherein as the first counterweight and the second counterweight move through a rearward half of the path, the first counterweight and the second counterweight generally move in an upward direction, and as the first counterweight and the second counterweight move through a forward half of the path, the first counterweight and the second counterweight generally move in a downward direction.

17. The reciprocating saw of claim 12, wherein the output shaft reciprocates along a spindle axis, and wherein the spindle axis is coaxial with the motor axis.

18. The reciprocating saw of claim 12, wherein the drive mechanism further comprises a connecting rod pivotably coupled to the first counterweight at a first end thereof about a pivot axis

19. A reciprocating saw comprising:
a housing;
a motor positioned within the housing, the motor including a pinion rotatable about a motor axis; and
a drive mechanism positioned within the housing and coupled to the motor, the drive mechanism including
a driven gear that engages the pinion and is rotated by the motor,
an output shaft driven by the motor to reciprocate relative to the housing along a spindle axis that is coaxial with the motor axis, the output shaft configured to support a tool element adjacent a forward portion of the housing,
a first counterweight extending along a main axis and coupled to the driven gear for rotation with the driven gear about a rotational axis,
a connecting rod pivotably coupled to the first counterweight at a first end thereof about a pivot axis, and
a second counterweight spaced apart from the first counterweight and integrally formed with the driven gear, wherein the first counterweight and the second counterweight are driven by the motor to rotate relative to the housing along a path,
wherein a center of mass of the first counterweight is offset from a reference plane intersecting and containing therein the rotational axis and the pivot axis,
wherein operation of the reciprocating saw generates vibration in a first direction extending along an X-axis that is collinear with the spindle axis, and in a second direction extending along a Y-axis that is orthogonal to the spindle axis, and
wherein the drive mechanism is configured to cut through a two-inch schedule 40 pipe with an X-axis vibration of 9 m/s² or less, while maintaining a Y-axis vibration of at least 5 m/s², within a time period of less than 23 seconds.

20. The reciprocating saw of claim 19, wherein the first counterweight includes a phase angle extending between the reference plane and a line of action intersecting the center of mass of the first counterweight and the rotational axis of the first counterweight.
